(19) United States
(12) Patent Application Publication
(10) Pub. No.: US 2024/0003937 A1
(43) Pub. Date: Jan. 4, 2024

(54) ON-BOARD CONTROL DEVICE AND ACCELERATION SENSOR DIAGNOSIS METHOD

(71) Applicant: Mitsubishi Electric Corporation, Chiyoda-ku, Tokyo (JP)

(72) Inventors: Makoto TOKUMARU, Tokyo (JP); Satoru MATSUOKA, Tokyo (JP); Koji SHIRATSUCHI, Tokyo (JP)

(73) Assignee: Mitsubishi Electric Corporation, Chiyoda-ku, Tokyo (JP)

(21) Appl. No.: 18/252,748

(22) PCT Filed: Nov. 24, 2020
(86) PCT No.: PCT/JP2020/043698

§ 371 Date: May 12, 2023

(51) Int. Cl. G01P 21/00; G01C 22/02; G01P 15/08; B61L 25/02

(52) U.S. Cl. CPC G01P 21/00; G01C 22/02; G01P 15/08; B61L 25/025

(57) ABSTRACT

An on-board control device includes a communication unit that is communicable with a tachometer, a pick-up coil, an acceleration sensor a detection axis of which is provided along a traveling direction of the train, and a master controller, a storage unit that stores information regarding a gradient value at each position on a train line where the train travels, and a control unit that specifies a train position by using information acquired from the pick-up coil and the tachometer, determines a traveling state from information acquired from the master controller, and when the train coasts or is stopped, diagnoses soundness of the acceleration sensor based on a comparison result obtained by comparing a first acceleration of the train output from the acceleration sensor with a second acceleration in the traveling direction calculated by using a gravity acceleration and a gradient value at the train position.

### FIELD

The present disclosure relates to an on-board control device to be installed in a train including an acceleration sensor, and an acceleration sensor diagnosis method.

### BACKGROUND

In recent train control systems such as a communications based train control (CBTC) or a digital automatic train control (ATC), an on-board control device installed in a train calculates a train position using a tachometer, a pick-up coil, or the like and calculates a brake pattern used to control train intervals based on the calculated train position. Therefore, it is important to accurately manage the train position by the on-board control device. However, when the on-board control device calculates the train position, a train speed, or the like using the tachometer, the pick-up coil, or the like, an error of the train position increases if slipping or sliding of wheels of the train occurs.

For such a problem, by installing an acceleration sensor, the train can detect slipping or sliding by comparing an acceleration detected by the acceleration sensor and an acceleration calculated from a signal of the tachometer and correct the train position, the train speed, or the like in a case where slipping or sliding is detected. In order to accurately detect slipping or sliding and correct the train position, the train speed, or the like, the train needs to periodically confirm soundness of the acceleration sensor. Patent Literature 1 discloses a technique for diagnosing an acceleration sensor by a vehicle control system.

### CITATION LIST

### Patent Literature

Patent Literature 1: Japanese Patent Application Laid-open No. 2016-137731

### SUMMARY

### Technical Problem

However, according to the related art described above, the vehicle control system includes a vibration source that vibrates the acceleration sensor in order to diagnose the soundness of the acceleration sensor. Therefore, there has been a problem in that a device configuration of the vehicle control system becomes complicated.

The present disclosure has been made in view of the above, and an object is to obtain an on-board control device that can periodically diagnose soundness of an acceleration sensor with a simple configuration.

### Solution to Problem

To solve the above problem and achieve an object, the present disclosure is directed to an on-board control device to be installed in a train. The on-board control device includes: a communication unit to be communicable with a tachometer that outputs pulses corresponding to the number of revolutions of wheels of the train, a pick-up coil that receives a telegraph that includes identification information of a ground coil from the ground coil, an acceleration sensor a detection axis of which is provided along a traveling direction of the train, and a master controller; a storage unit to store information regarding a gradient value at each position on a train line where the train travels; and a control unit to specify a train position of the train by using information acquired from the pick-up coil and the tachometer, determine a traveling state of the train from information acquired from the master controller, and, when the train coasts or is stopped, diagnose soundness of the acceleration sensor based on a comparison result obtained by comparing a first acceleration of the train output from the acceleration sensor with a second acceleration in a traveling direction of the train calculated by using a gravity acceleration and a gradient value at the train position.

### Advantageous Effects of Invention

According to the present disclosure, an effect can be obtained that an on-board control device can periodically diagnose soundness of an acceleration sensor with a simple configuration.

### BRIEF DESCRIPTION OF DRAWINGS

FIG. 1 is a diagram illustrating a configuration example of a train control system according to a first embodiment.

FIG. 2 is a diagram illustrating an installation example of an acceleration sensor included in a train according to the first embodiment.

FIG. 3 is a block diagram illustrating a configuration example of an on-board control device according to the first embodiment.

FIG. 4 is a diagram illustrating an example of information stored in a storage unit of the on-board control device according to the first embodiment.

FIG. 5 is a flowchart illustrating an operation of the on-board control device according to the first embodiment.

FIG. 6 is a flowchart illustrating an operation for determining whether or not the acceleration sensor is normal by the on-board control device according to the first embodiment.

FIG. 7 is a flowchart illustrating an operation for detecting slipping or sliding using a tachometer and the acceleration sensor in a case where the acceleration sensor is normal and executing correction processing, by the on-board control device according to the first embodiment.

FIG. 8 is a flowchart illustrating an operation of the on-board control device for detecting slipping or sliding using the tachometer and executing the correction processing when the acceleration sensor is anomalous, according to the first embodiment.

FIG. 9 is a diagram illustrating an example when processing circuitry included in the on-board control device according to the first embodiment includes a processor and a memory.

FIG. 10 is a diagram illustrating an example when the processing circuitry included in the on-board control device according to the first embodiment includes dedicated hardware.

FIG. 11 is a diagram illustrating a configuration example of a train control system according to a second embodiment.

FIG. 12 is a diagram illustrating an installation example of a biaxial acceleration sensor included in a train according to the second embodiment.

FIG. 13 is a flowchart illustrating an operation of an on-board control device according to the second embodiment.

FIG. 14 is a flowchart illustrating an operation for determining whether or not the biaxial acceleration sensor is normal by the on-board control device according to the second embodiment.

FIG. 15 is a diagram illustrating a configuration example of the biaxial acceleration sensor included in the train according to the second embodiment.

### DESCRIPTION OF EMBODIMENTS

Hereinafter, an on-board control device and an acceleration sensor diagnosis method according to embodiments of the present disclosure will be described in detail with reference to the drawings.

### First Embodiment

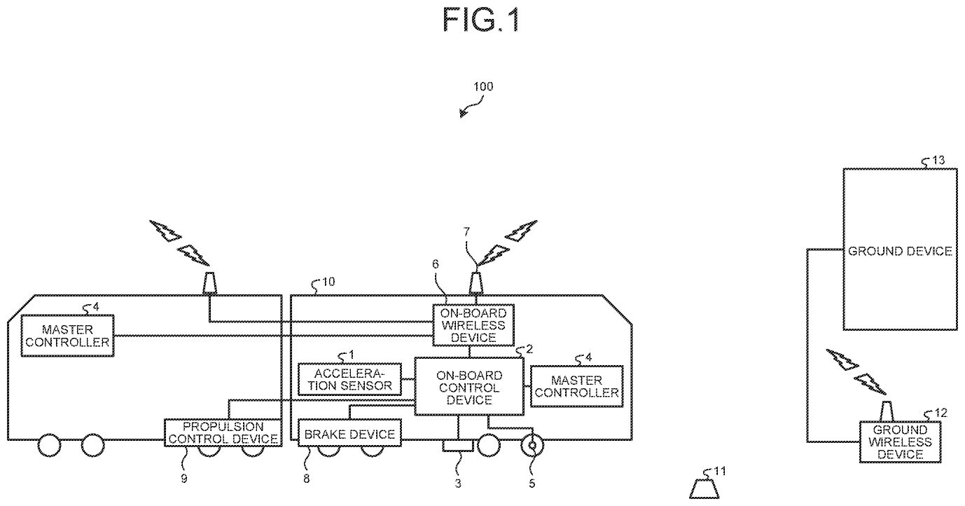

FIG. 1 is a diagram illustrating a configuration example of a train control system 100 according to a first embodiment. The train control system 100 includes a train 10, a ground coil 11, a ground wireless device 12, and a ground device 13. The train 10 includes an acceleration sensor 1, an on-board control device 2, a pick-up coil 3, a master controller 4, a tachometer 5, an on-board wireless device 6, an on-board antenna 7, a brake device 8, and a propulsion control device 9.

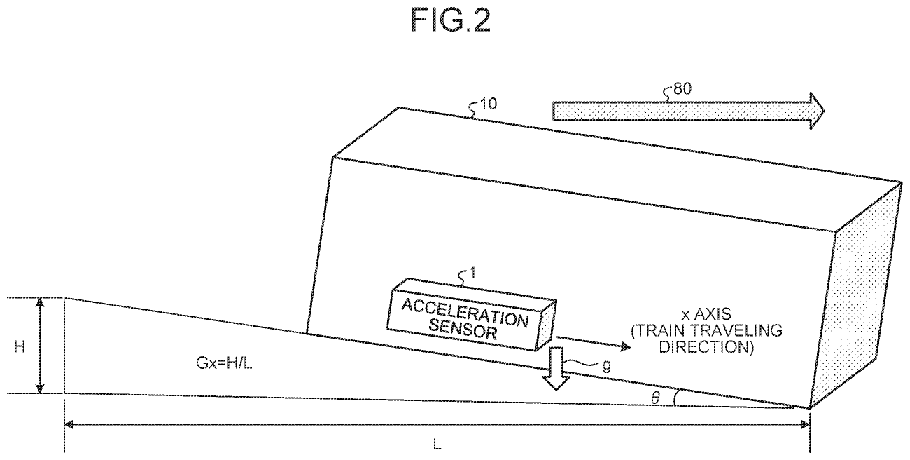

The acceleration sensor 1 is installed such that a first detection axis that is a detection axis is provided along a traveling direction of the train 10. FIG. 2 is a diagram illustrating an installation example of the acceleration sensor 1 included in the train 10 according to the first embodiment. It is assumed that the train 10 is oriented toward a direction indicated by an arrow 80 and travels. To simplify the description, in FIG. 2, only the train 10 and the acceleration sensor 1 installed in the train 10 are schematically illustrated. Furthermore, in FIG. 2, the traveling direction of the train 10 is represented by an x axis. The acceleration sensor 1 detects a first acceleration, which is an acceleration in the traveling direction of the train 10, and outputs the first acceleration to the on-board control device 2. Note that, in FIG. 2, a gradient value at a train position of the train 10 to be described later and a gravity acceleration g applied to the train 10 are illustrated.

The pick-up coil 3 receives a telegraph including an identifier (ID) that is identification information of the ground coil 11 from the ground coil 11 installed on the ground, and outputs the ID of the ground coil 11 to the on-board control device 2.

The master controller 4 is provided around an operator's seat (not illustrated) of the train 10 and accepts an operation by an operator. In FIG. 1, an example is illustrated in which the train 10 includes the master controllers 4 in a first car and a rear car. The master controller 4 outputs information regarding an operation state of a powering notch, a brake notch, or the like received from the operator, to the on-board control device 2. The information regarding the operation state of the powering notch, the brake notch, or the like output from the master controller 4 to the on-board control device 2 is information indicating a traveling state of the train 10, for example, information indicating whether the train 10 is in an acceleration state, a deceleration state, or a coasting state.

The tachometer 5 generates pulses corresponding to the number of revolutions of a wheel of the train 10 and outputs the generated pulses to the on-board control device 2.

The on-board wireless device 6 performs wireless communication with the ground wireless device 12. The on-board wireless device 6 transmits data such as positional information on the train 10 that is calculated by the on-board control device 2 and acquired from the on-board control device 2 to the ground wireless device 12 through wireless communication via the on-board antenna 7. Furthermore, the on-board wireless device 6 receives control information such as information on stop limit of the train 10 calculated by the ground device 13 from the ground wireless device 12 through wireless communication via the on-board antenna 7.

The brake device 8 executes processing for deceleration, processing for stop, or the like of the train 10, based on a brake command from the on-board control device 2.

The propulsion control device 9 drives an electric motor that rotates the wheels based on a driving command from the on-board control device 2 and executes acceleration processing of the train 10.

The on-board control device 2 is installed in the train 10 and controls traveling and stop of the train 10 at the time of the operation of the train 10. The on-board control device 2 periodically calculates the train position of the train 10. Specifically, the on-board control device 2 calculates a train speed, a traveling distance, or the like of the train 10 from the number of pulses acquired from the tachometer 5 and a diameter of the wheel of the train 10 and further calculates the train position of the train 10 using the telegraph acquired from the pick-up coil 3, that is, positional information on the ground coil 11. The on-board control device 2 transmits the calculated positional information to the ground wireless device 12 via the on-board wireless device 6 and the on-board antenna 7. Furthermore, the on-board control device 2 receives the information on stop limit of the train 10 calculated by the ground device 13 from the ground wireless device 12 via the on-board antenna 7 and the on-board wireless device 6. The on-board control device 2 generates a stop deceleration pattern using the information on stop limit or the like and controls traveling of the train 10 using the generated stop deceleration pattern. Specifically, when the train speed of the train 10 exceeds the stop deceleration pattern, the on-board control device 2 outputs the brake command to the brake device 8. Furthermore, the on-board control device 2 periodically diagnoses soundness of the acceleration sensor 1. An operation for periodically diagnosing the soundness of the acceleration sensor 1 by the on-board control device 2 will be described later.

In the train control system 100, a ground system including devices provided on the ground includes the ground coil 11, the ground wireless device 12, and the ground device 13.

The ground coil 11 transmits a telegraph including the ID that is the identification information of the ground coil 11. Note that, although only one ground coil 11 is illustrated in the example in FIG. 1, the plurality of ground coils 11 is actually provided at specified intervals on a train line where the train 10 travels.

The ground wireless device 12 performs wireless communication with the train 10, specifically, the on-board wireless device 6 via the on-board antenna 7. The ground wireless device 12 receives the data such as the positional information on the train 10 calculated by the train 10 through wireless communication. Furthermore, the ground wireless device 12 transmits the control information such as the information on stop limit of the train 10 calculated by the ground device 13 to the train 10 through wireless communication.

The ground device 13 is connected to the ground wireless device 12, receives the positional information on the train 10 from the on-board control device 2 of the train 10 via the on-board wireless device 6, the on-board antenna 7, and the ground wireless device 12 and manages the positional information on the train 10 that travels in a jurisdiction area. Note that one train 10 is illustrated in the example in FIG. 1. However, the ground device 13 can manage pieces of positional information on the plurality of trains 10. When the plurality of trains 10 is traveling in the jurisdiction area, the ground device 13 calculates stop limits for the plurality of trains 10, based on the pieces of positional information on the plurality of trains 10, in order to manage intervals for the plurality of trains 10. The ground device 13 transmits the information on stop limit indicating the stop limit of the train 10 obtained by calculation to the on-board control device 2 of the train 10, via the ground wireless device 12, the on-board antenna 7, and the on-board wireless device 6. Furthermore, the ground device 13 generates the control information such as deceleration information based on the positional information on the plurality of trains 10 and transmits the control information to the on-board control device 2 of the train 10 via the ground wireless device 12, the on-board antenna 7, and the on-board wireless device 6.

In the example in FIG. 1, an example in which the train control system 100 is applied to a wireless train control system is illustrated. However, the train control system 100 is not limited to this. The train control system 100 can be applied to a system that includes a digital ATC device in which the ground device 13 detects the train positions of the plurality of trains 10 using a track circuit and transmits a position of a preceding train to the on-board control device 2 via the track circuit.

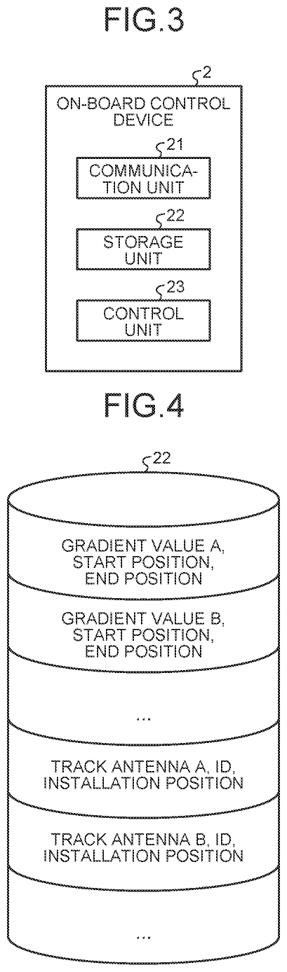

Subsequently, the operation for periodically diagnosing the soundness of the acceleration sensor 1 by the on-board control device 2 and the configuration of the on-board control device 2 will be described in detail. FIG. 3 is a block diagram illustrating a configuration example of the on-board control device 2 according to the first embodiment. The on-board control device 2 includes a communication unit 21, a storage unit 22, and a control unit 23.

The communication unit 21 communicates with the acceleration sensor 1, the pick-up coil 3, the master controller 4, the tachometer 5, the on-board wireless device 6, the brake device 8, and the propulsion control device 9.

The storage unit 22 stores information regarding a gradient value at each position on the train line where the train 10 travels, and information in which the ID of the ground coil 11 and the installation position of the ground coil 11 are associated. FIG. 4 is a diagram illustrating an example of information stored in the storage unit 22 of the on-board control device 2 according to the first embodiment. FIG. 4 illustrates an example in which the storage unit 22 stores pieces of the information described above in a form of a database. The storage unit 22 stores a specific gradient value, a gradient start position according to the gradient value, and a gradient end position according to the gradient value, as the information regarding the gradient value at each position on the train line where the train 10 travels. Furthermore, the storage unit 22 stores information regarding the ID and the installation position of each ground coil 11 as the information in which the ID of the ground coil 11 and the installation position of the ground coil 11 are associated.

The control unit 23 specifies the train position of the train 10 using the information acquired from the pick-up coil 3 and the information acquired from the tachometer 5. Specifically, the control unit 23 specifies the train position of the train 10 using the ID of the ground coil 11 received from the ground coil 11 via the pick-up coil 3 and the communication unit 21, and the installation position of the ground coil 11 corresponding to the ID of the ground coil 11 stored in the storage unit 22. The control unit 23 calculates a traveling distance from the ground coil 11 based on the number of pulses corresponding to the number of revolutions of the wheel obtained from the tachometer 5, and updates the train position of the train 10 as needed. The control unit 23 determines a traveling state of the train 10 from the information acquired from the master controller 4. Specifically, the control unit 23 determines whether the train 10 is accelerating, decelerating, coasting, or stopped. The control unit 23 compares a first acceleration that is an acceleration of the train 10 output from the acceleration sensor 1 with a second acceleration, which is an acceleration in the traveling direction of the train 10 calculated using the gravity acceleration g and the gradient value at the train position of the train 10, when the train 10 is coasting or stopped. The second acceleration is a component of the gravity acceleration g in the train traveling direction. The control unit 23 diagnoses the soundness of the acceleration sensor 1, based on a comparison result.

In general, when the train 10 accelerates or decelerates under a special situation in which a surface of the railway track where the train 10 is traveling is wet, wheel slipping or sliding may occur. When slipping or sliding of the wheel of the train 10 occurs, the number of pulses generated by the tachometer 5 does not match an actual train speed, traveling distance, or the like of the train 10. Therefore, the on-board control device 2 executes processing for determining whether or not slipping or sliding of the wheel of the train 10 has occurred, and correcting the train position of the train 10 if slipping or sliding has occurred. Here, in the train 10, the acceleration sensor 1 is not affected by slipping, sliding, or the like of the wheel. Therefore, if the acceleration sensor 1 is in a sound state, it is preferable that the on-board control device 2 detects idling or sliding of the wheel using the acceleration output from the acceleration sensor 1 that is not affected by slipping, sliding, or the like of the wheel, and performs correction when slipping or sliding has occurred. Therefore, the on-board control device 2 periodically diagnoses the soundness of the acceleration sensor 1.

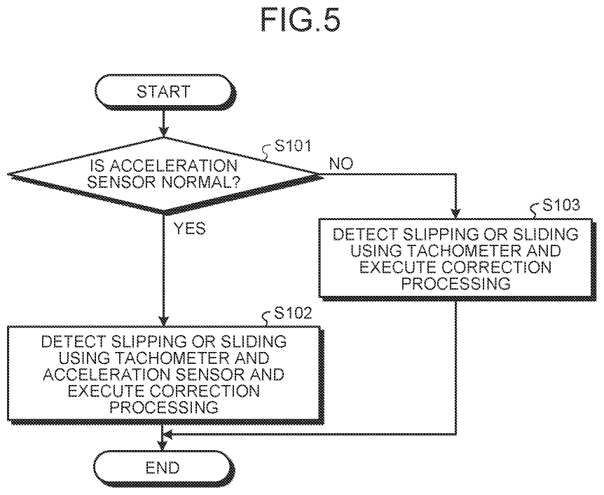

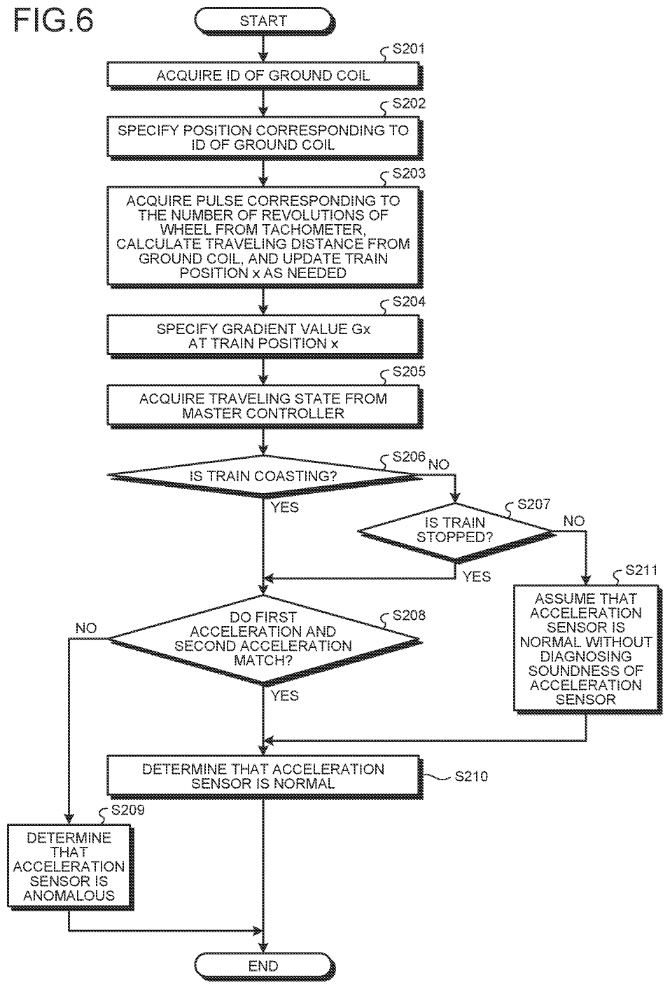

FIG. 5 is a flowchart illustrating an operation of the on-board control device 2 according to the first embodiment. As described above, in the on-board control device 2, communication with other components is performed by the communication unit 21, and all the other operations are performed by the control unit 23. Therefore, for simplicity, the description is made with the on-board control device 2 being the subject. The on-board control device 2 determines whether or not the acceleration sensor 1 is normal (step S101). An operation for determining whether or not the acceleration sensor 1 is normal by the on-board control device 2 will be described in detail. FIG. 6 is a flowchart illustrating the operation for determining whether or not the acceleration sensor 1 is normal by the on-board control device 2 according to the first embodiment. The flowchart illustrated in FIG. 6 indicates details of the operation in step S101 in the flowchart illustrated in FIG. 5.

The on-board control device 2 acquires the ID of the ground coil 11 via the pick-up coil 3 (step S201). The on-board control device 2 specifies a position corresponding to the ID of the ground coil 11, based on the information in which the ID of the ground coil 11 and the installation position of the ground coil 11 are associated and stored in the storage unit 22 (step S202). The on-board control device 2 acquires pulses corresponding to the number of revolutions of the wheel of the train 10 from the tachometer 5, calculates the traveling distance from the ground coil 11, and updates a train position x of the train 10 as needed (step S203). The on-board control device 2 specifies a gradient value Gx at the train position x of the train 10 (step S204). As described above, the storage unit 22 stores a gradient value at each position on the train line where the train 10 travels, that is, the gradient value Gx corresponding to the train position x of the train 10. An expression method of the gradient value Gx, that is, a unit is %, h, or the like. Here, in order to simplify a coefficient, as illustrated in FIG. 2, it is assumed that the gradient value Gx=H/L from a distance L of traveling in the horizontal direction and a height H that has changed at the time of traveling by the distance L. In general, since an upper limit of the gradient of the train line of railroads is assumed as about 500, this is because it can be assumed that sin θ≈tan θ=H/L with such a small angle θ. The on-board control device 2 acquires information regarding the traveling state of the train 10 from the master controller 4 (step S205).

When the train 10 is coasting (step S206: Yes) or when the train 10 is not coasting (step S206: No) but is stopped (step S207: Yes), the on-board control device 2 determines whether or not the first acceleration detected by the acceleration sensor 1 matches the second acceleration that is the component of the gravity acceleration g (step S208) in the traveling direction of train. If the train 10 is coasting (step S206: Yes) or stopped (step S207: Yes), an acceleration other than the acceleration caused by the gravity acceleration g is not generated; accordingly, the first acceleration output from the acceleration sensor 1 has the same value as that of the second acceleration, that is, “g×sin θ≈g×Gx”, the component of the gravity acceleration g in the train traveling direction. The on-board control device 2 may calculate a difference between the first acceleration (a_Sen_x) and the second acceleration (g×Gx), in consideration of a measurement error or the like of the acceleration sensor 1 and determine that the accelerations match when an absolute value of the difference falls within a first threshold THRE1. The first threshold THRE1 is a threshold that is specified in advance in consideration of the measurement error or the like of the acceleration sensor 1, and is, for example, stored in the storage unit 22. Note that, the on-board control device 2 can detect whether the train 10 is in an acceleration state, a deceleration state, or a coasting state because the on-board control device 2 acquires the information regarding the traveling state from the master controller 4. Furthermore, the on-board control device 2 can detect whether the train 10 is stopped because the on-board control device 2 has acquired the pulses corresponding to the number of revolutions of the wheel from the tachometer 5.

When the first acceleration and the second acceleration do not match (step S208: No), the on-board control device 2 determines that the acceleration sensor 1 is anomalous (step S209). When the first acceleration and the second acceleration match (step S208: Yes), the on-board control device 2 determines that the acceleration sensor 1 is normal (step S210). Note that, when the train 10 is not coasting (step S206: No) and the train 10 is not stopped (step S207: No), the on-board control device 2 assumes that the acceleration sensor 1 is normal without diagnosing the soundness of the acceleration sensor 1 at this operation (step S211) and determines that the acceleration sensor 1 is normal (step S210).

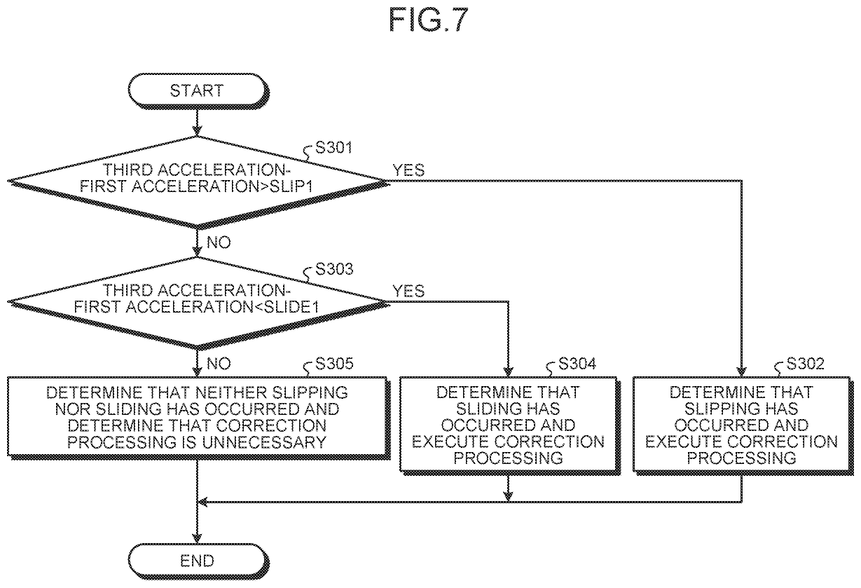

The description returns to the flowchart in FIG. 5. When the acceleration sensor 1 is normal (step S101: Yes), the on-board control device 2 performs detection for slipping or sliding using the tachometer 5 and the acceleration sensor 1, and executes the correction processing if slipping or sliding is detected (step S102). FIG. 7 is a flowchart illustrating an operation, by the on-board control device 2 according to the first embodiment, for detecting slipping or sliding using the tachometer 5 and the acceleration sensor 1 when the acceleration sensor 1 is normal and executing the correction processing. The on-board control device 2 calculates a third acceleration (α_TM) from the pulse output from the tachometer 5. The on-board control device 2 compares the calculated third acceleration (α_TM) with the first acceleration (α_Sen_x) detected by the acceleration sensor 1. Specifically, the on-board control device 2 calculates a difference between the third acceleration (α_TM) and the first acceleration (α_Sen_x).

When the difference between the third acceleration (α_TM) and the first acceleration (α_Sen_x) is larger than a first slipping threshold SLIP1 used to detect slipping (step S301: Yes), the on-board control device 2 determines that slipping of the wheel of the train 10 has occurred and executes the correction processing (step S302). Specifically, while the slipping state continues, the on-board control device 2 calculates the train speed and the train position of the train 10 using the first acceleration (α_Sen_x) output from the acceleration sensor 1.

When the difference between the third acceleration (α_TM) and the first acceleration (α_Sen_x) is equal to or less than the first slipping threshold SLIP1 (step S301: No) and is smaller than a first sliding threshold SLIDE1 used to detect sliding (step S303: Yes), the on-board control device 2 determines that sliding of the wheel of the train 10 has occurred and executes the correction processing (step S304). Specifically, while the sliding state continues, the on-board control device 2 calculates the train speed and the train position of the train 10 using the first acceleration (α_Sen_x) output from the acceleration sensor 1.

When the difference between the third acceleration (α_TM) and the first acceleration (α_Sen_x) is equal to or more than the first sliding threshold SLIDE1 (step S303: No), the on-board control device 2 determines that neither sliding nor slipping of the wheel of the train 10 has occurred and determines that the correction processing is unnecessary (step S305). In this way, the on-board control device 2 determines whether slipping has occurred or not based on a comparison result obtained by comparing the calculated difference with the first slipping threshold used to detect slipping, and determines whether or not sliding has occurred based on a comparison result obtained by comparing the calculated difference with the first sliding threshold used to detect sliding.

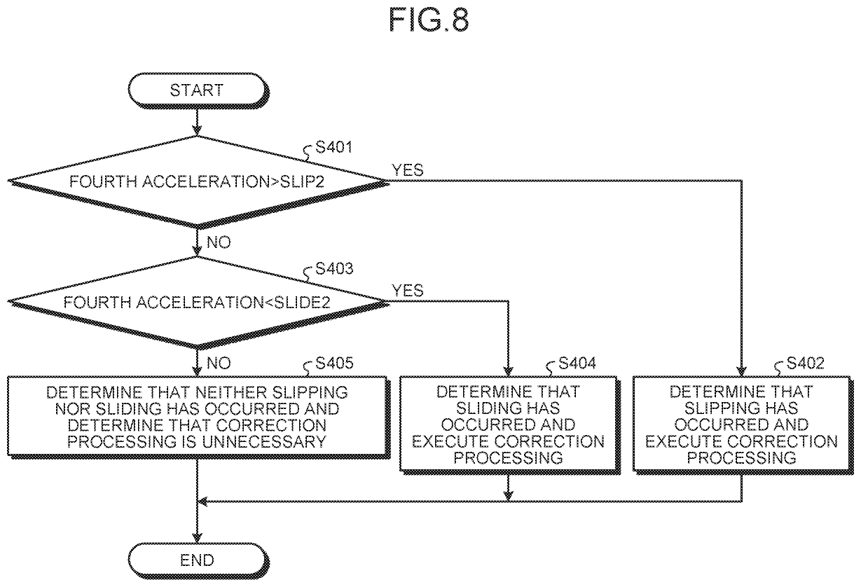

The description returns to the flowchart in FIG. 5. When the acceleration sensor 1 is anomalous (step S101: No), the on-board control device 2 detects slipping or sliding using the tachometer 5 and executes the correction processing when slipping or sliding is detected (step S103). FIG. 8 is a flowchart illustrating an operation of the on-board control device 2 for detecting slipping or sliding using the tachometer 5 and executing the correction processing when the acceleration sensor 1 is anomalous, according to the first embodiment. The on-board control device 2 calculates a fourth acceleration of the train 10 from an increment of the pulses per unit time of the tachometer 5. Specifically, the on-board control device 2 calculates the fourth acceleration of the train 10 using the number of pulses per unit time T0 of the tachometer 5, for example, using the number of pulses P1 per unit time T0 between t1 seconds to t2 seconds and the number of pulses P1+N1 increased by N1 pulses in the next unit time T0 between t2 seconds to t3 seconds.

When the fourth acceleration is larger than a second slipping threshold SLIP2 used to detect slipping (step S401: Yes), the on-board control device 2 determines that slipping of the wheel of the train 10 has occurred and executes the correction processing (step S402).

Specifically, when the on-board control device 2 detects slipping and calculates the train position of the train 10 based on the pulse of the speed generator 5, a calculated head position of the of the train 10 is ahead of an actual head position of the train 10, and a margin for control is secured. Therefore, a pulse signal of the tachometer 5 is used as it is. On the other hand, a calculated rear position of the train 10 is ahead of an actual rear position of the train 10, which results in calculating a position for stop limit of the subsequent train with less margin for control. Therefore, for example, the on-board control device 2 performs correction so as to secure the margin for control with a method for calculating the train position of the train 10 on the assumption that the train 10 has traveled at a constant speed from a time m1 seconds before the time when slipping is detected, for example.

When the fourth acceleration is equal to or less than the second slipping threshold SLIP2 (step S401: No) and is smaller than a second sliding threshold SLIDE2 used to detect sliding (step S403: Yes), the on-board control device 2 determines that sliding of the wheel of the train 10 has occurred and executes the correction processing (step S404). Specifically, when the on-board control device 2 detects sliding and calculates the train position of the train 10 based on the pulse signal of the speed generator 5, the calculated head position of the train 10 is behind the actual head position of the train 10, which reduces margin for control because the on-board control device 2 determines a timing to output the brake command based on a decision that separation from the brake pattern is larger than actual separation. Therefore, the on-board control device 2 performs correction for securing the margin for control with a method for calculating the train position of the train 10 or the like on the assumption with that the train has traveled at a constant speed from a time m2 seconds before the time when sliding is detected, for example. On the other hand, the calculated rear position of the train 10 is behind the actual rear position of the train 10, the stop limit position of the subsequent train is calculated with margin for control secured. Therefore, the on-board control device 2 uses the pulse signal of the tachometer 5 as it is.

When the fourth acceleration is equal to or more than the second sliding threshold SLIDE2 (step S403: No), the on-board control device 2 determines that neither slipping nor sliding of the wheel of the train 10 has occurred, and determines that the correction is unnecessary (step S405). As above, the on-board control device 2 determines whether or not slipping occurs based on a comparison result obtained by comparing the fourth acceleration with the threshold used to detect slipping, and determines whether or not sliding occurs based on a comparison result obtained by comparing the fourth acceleration with the threshold used to detect sliding.

When the acceleration sensor 1 is anomalous (step S101: No), the on-board control device 2 does not use the signal of the acceleration sensor 1, detects slipping or sliding with only the pulse signal of the tachometer 5, and performs correction if slipping or sliding is detected. In this case, a true train position, train speed, acceleration, or the like of the train 10 under slipping or sliding is unknown. Therefore, in order to secure the margin for control, the on-board control device 2 needs to execute excessive correction for speed and position using, for example, a physical limit value, a performance limit value, or the like such as a train maximum acceleration, a train maximum deceleration, and a maximum gradient. Therefore, in the train control system 100, train intervals of the plurality of trains 10 may excessively increase.

On the other hand, when the acceleration sensor 1 is normal (step S101: Yes), the on-board control device 2 can detect slipping or sliding of the wheel of the train 10 using the signal of the acceleration sensor 1 that is not affected even when the wheel of the train 10 slips or slides, and perform correction if slipping or sliding has been detected. As a result, the train intervals of the trains 10 do not become excessive, which results in stabilizing transportation density in the train control system 100.

Subsequently, a hardware configuration of the on-board control device 2 will be described. In the on-board control device 2, the communication unit 21 is an interface such as a communication device. The storage unit 22 is a memory. The control unit 23 is implemented by processing circuitry. The processing circuitry may be a processor and a memory that executes programs stored in the memory or may be dedicated hardware.

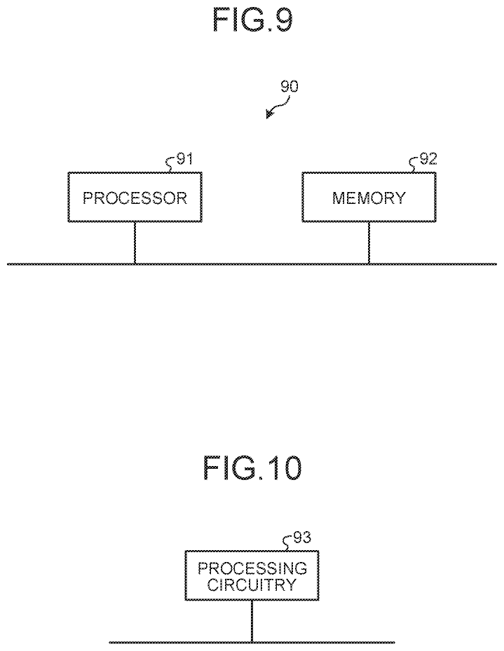

FIG. 9 is a diagram illustrating an example where processing circuitry 90 included in the on-board control device 2 according to the first embodiment includes a processor 91 and a memory 92. When the processing circuitry 90 includes the processor 91 and the memory 92, each function of the processing circuitry 90 of the on-board control device 2 is implemented by software, firmware, or a combination of software and firmware. The software or the firmware is described as a program and is stored in the memory 92. The processing circuitry 90 implements each function by reading and executing the program stored in the memory 92 by the processor 91. That is, the processing circuitry 90 includes the memory 92 that stores the program that results in executing the processing of the on-board control device 2. Furthermore, it can be said that these programs are programs for causing a computer to execute a procedure and a method of the on-board control device 2.

Here, the processor 91 may be a central processing unit (CPU), a processing device, an arithmetic device, a microprocessor, a microcomputer, a digital signal processor (DSP), or the like. Furthermore, the memory 92 is, for example, a non-volatile or volatile semiconductor memory such as a random access memory (RAM), a read only memory (ROM), a flash memory, an erasable programmable ROM (EPROM), and an Electrically EPROM (EEPROM) (registered trademark), a magnetic disk, a flexible disk, an optical disk, a compact disk, a mini disk, or a digital versatile disc (DVD).

FIG. 10 is a diagram illustrating an example when processing circuitry 93 included in the on-board control device 2 according to the first embodiment includes dedicated hardware. When the processing circuitry 93 includes the dedicated hardware, the processing circuitry 93 illustrated in FIG. 10 is, for example, a single circuit, a composite circuit, a programmed processor, a parallel-programmed processor, an application specific integrated circuit (ASIC), a field-programmable gate array (FPGA), or a combination thereof. Each function of the on-board control device 2 may be implemented by the processing circuitry 93 for each function, and the functions may be collectively implemented by the processing circuitry 93.

Note that some of the functions of the on-board control device 2 may be implemented by dedicated hardware, and some of the functions may be implemented by software or firmware. In this way, the processing circuitry can implement each function described above by the dedicated hardware, software, firmware, or the combination thereof.

As described above, according to the present embodiment, the on-board control device 2 installed in the train 10 diagnoses the soundness of the acceleration sensor 1 based on the comparison result obtained by comparing the first acceleration detected by the acceleration sensor 1 and the second acceleration that is the component of the gravity acceleration g in the traveling direction of train, when the train 10 is coasting or stopped. Thus, the on-board control device 2 can periodically diagnose the soundness of the acceleration sensor 1 with a simple configuration, without using a vibration source that vibrates the acceleration sensor 1 while the train 10 is traveling. When the acceleration sensor 1 is normal, the on-board control device 2 can improve accuracy in detecting slipping or sliding and can prevent or reduce excessive correction on slipping or sliding even when slipping or sliding has occurred.

### Second Embodiment

In a second embodiment, a case will be described where a train includes a biaxial acceleration sensor.

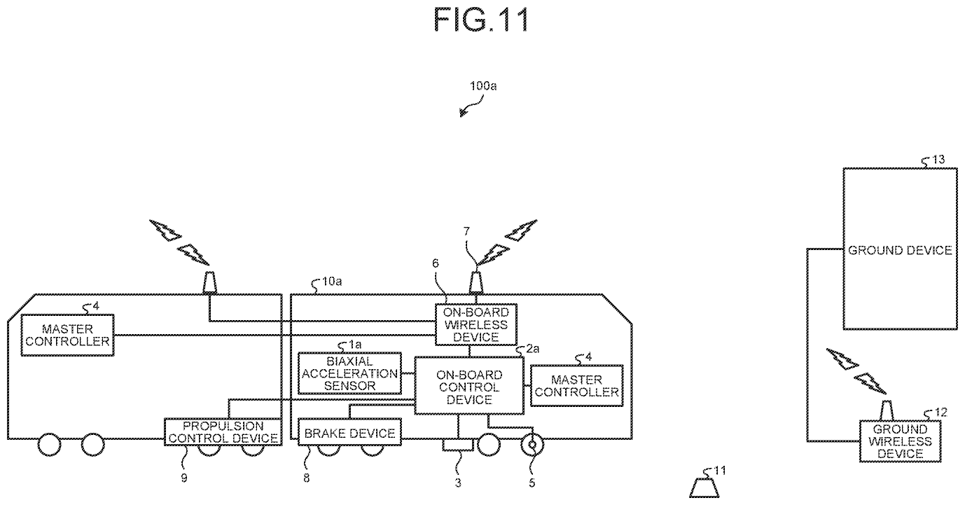

FIG. 11 is a diagram illustrating a configuration example of a train control system 100a according to the second embodiment. In the train control system 100a, the train 10 in the train control system 100 according to the first embodiment illustrated in FIG. 1 is replaced with a train 10a. In the train 10a, the acceleration sensor 1 and the on-board control device 2 in the train 10 according to the first embodiment illustrated in FIG. 1 are replaced with a biaxial acceleration sensor 1a and an on-board control device 2a, respectively.

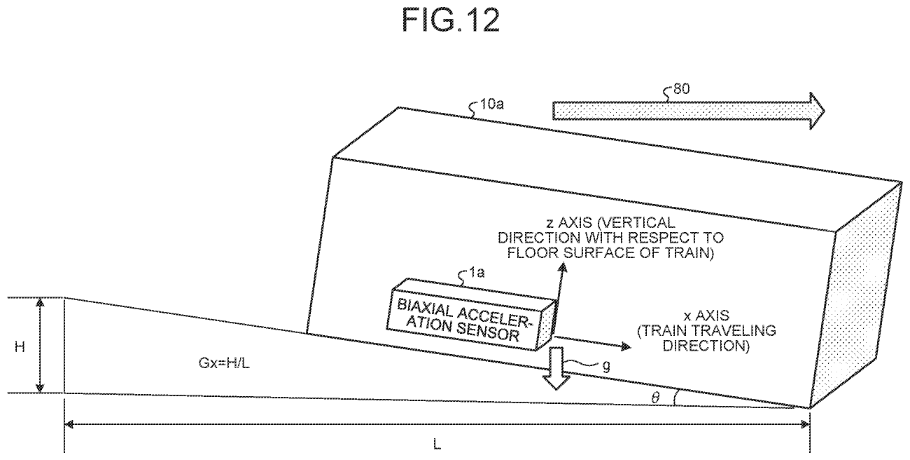

The biaxial acceleration sensor 1a is an acceleration sensor that includes a first detection axis and a second detection axis. The biaxial acceleration sensor 1a is installed such that the first detection axis is provided along a traveling direction of the train 10a, and the second detection axis is provided to be perpendicular to the first detection axis and along a vertical direction with respect to a floor surface of the train 10a. FIG. 12 is a diagram illustrating an installation example of the biaxial acceleration sensor 1a included in the train 10a according to the second embodiment. It is assumed that the train 10a is oriented to the direction indicated by the arrow 80 and travels. To simplify the description, in FIG. 12, only the train 10a and the biaxial acceleration sensor 1a installed in the train 10a are schematically illustrated. Furthermore, in FIG. 12, the traveling direction of the train 10a is represented by an x axis, and the vertical direction with respect to the floor surface of the train 10a is represented by a z axis. The biaxial acceleration sensor 1a detects a first acceleration that is an acceleration in the traveling direction of the train 10a, detects a fifth acceleration that is an acceleration in the vertical direction with respect to the floor surface of the train 10a, and outputs the accelerations to the on-board control device 2a.

When the biaxial acceleration sensor 1a is disposed in the train 10a in this way, an output component in the z-axis direction of the biaxial acceleration sensor 1a, that is, the fifth acceleration should match a value that is uniquely determined based on only a gradient value at a position of the train 10a, regardless of the acceleration of the train 10a, if the biaxial acceleration sensor 1a is normal. As illustrated in FIG. 12, when the gradient value Gx=H/L (angle θ) is satisfied, an output component in the z-axis direction of the gravity acceleration g, that is, a sixth acceleration is g×cos θ=g×√(1−sin²θ)≈g×√(1−Gx²).

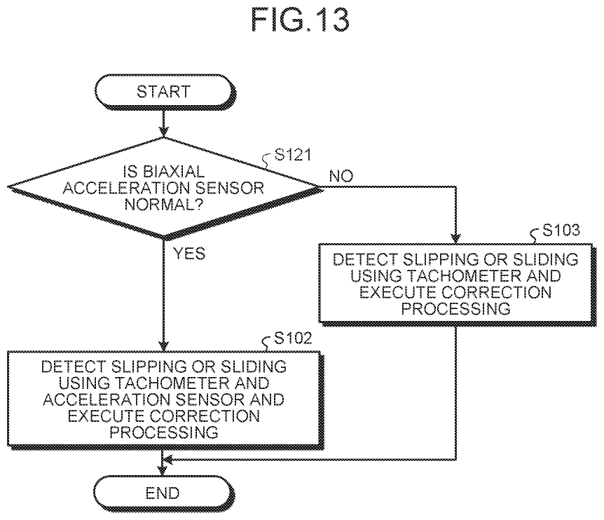

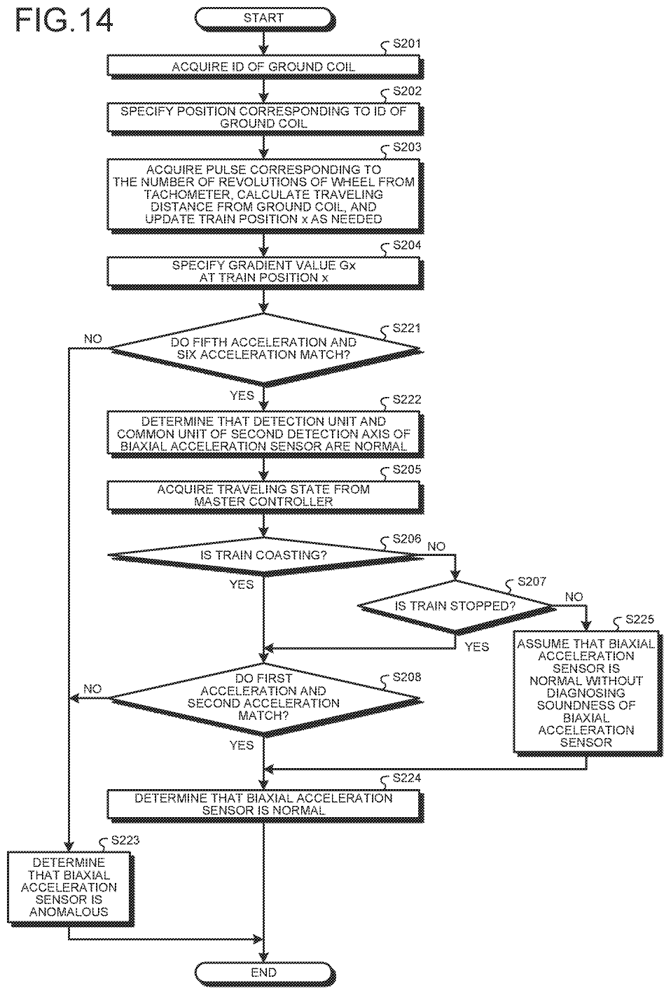

A configuration of the on-board control device 2a is similar to the configuration of the on-board control device 2 according to the first embodiment illustrated in FIG. 3. The on-board control device 2a performs an operation similar to that of the on-board control device 2 according to the first embodiment. However, an operation for determining whether or not the biaxial acceleration sensor 1a is normal is different. FIG. 13 is a flowchart illustrating the operation of the on-board control device 2a according to the second embodiment. The on-board control device 2a determines whether or not the biaxial acceleration sensor 1a is normal (step S121). Note that, operations in steps S102 and S103 in FIG. 13 are the same as the operations in steps S102 and S103 in the flowchart according to the first embodiment illustrated in FIG. 5. The operation for determining whether or not the biaxial acceleration sensor 1a is normal by the on-board control device 2a will be described in detail. FIG. 14 is a flowchart illustrating the operation for determining whether or not the biaxial acceleration sensor 1a is normal by the on-board control device 2a according to the second embodiment. The flowchart illustrated in FIG. 14 indicates details of the operation in step S121 in the flowchart illustrated in FIG. 13. In the flowchart illustrated in FIG. 14, operations in step S201 to step S204 are the same as the operations in step S201 to step S204 in the flowchart according to the first embodiment illustrated in FIG. 6.

The on-board control device 2a determines whether or not the fifth acceleration (α_Sen_z) regarding the second detection axis output from the biaxial acceleration sensor 1a, matches the sixth acceleration (g×√(1−Gx²)) in the vertical direction with respect to the floor surface of the train 10 that is calculated using the gravity acceleration g and the gradient value Gx at the train position (step S221). The on-board control device 2a may calculate a difference between the fifth acceleration (α_Sen_z) and the sixth acceleration (g×√(1−Gx²)) in consideration of a measurement error or the like of the biaxial acceleration sensor 1a, and determine that the accelerations match when an absolute value of the difference is within a second threshold THRE2. The second threshold is specified in advance in consideration of the measurement error or the like of the biaxial acceleration sensor 1a, and is, for example, stored in a storage unit 22. The on-board control device 2a performs the determination in step S221, regardless of a traveling state of the train 10a. If the fifth acceleration and the sixth acceleration match (step S221: Yes), the on-board control device 2a determines that a detection unit and a common unit of the second detection axis are normal by the biaxial acceleration sensor 1a (step S222).

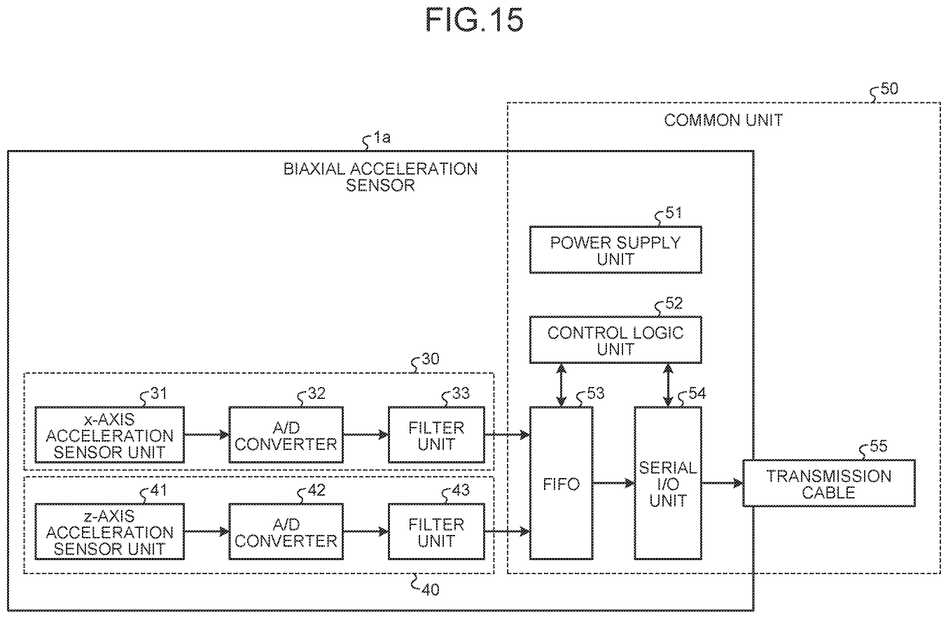

FIG. 15 is a diagram illustrating a configuration example of the biaxial acceleration sensor 1a included in the train 10a according to the second embodiment. The biaxial acceleration sensor 1a includes detection units 30 and 40 and a common unit 50. The detection unit 30 is a detection unit of the first detection axis that includes an x-axis acceleration sensor unit 31, an analog to digital (A/D) converter 32, and a filter unit 33. The detection unit 40 is a detection unit of the second detection axis that includes a z-axis acceleration sensor unit 41, an A/D converter 42, and a filter unit 43. The common unit 50 includes a power supply unit 51, a control logic unit 52, a first in first out (FIFO) 53, a serial input/output (I/O) unit 54, and a transmission cable 55. The common unit 50 is used by the detection units 30 and 40 in common. The acceleration sensor 1 according to the first embodiment can diagnose a failure only when the train 10 is stopped or coasting. However, the biaxial acceleration sensor 1a of the on-board control device 2a can constantly diagnose a failure of the detection unit 40 that is the detection unit of the second detection axis and the common unit 50 in step S222. In this way, the on-board control device 2a can diagnose the soundness of the detection unit 40 and the common unit 50 included in the biaxial acceleration sensor 1a, regardless of the traveling state of the train 10a, based on the comparison result obtained by comparing the fifth acceleration regarding the second detection axis output from the biaxial acceleration sensor 1a with the sixth acceleration in the vertical direction with respect to the floor surface of the train 10a that is calculated using the gravity acceleration g and the gradient value at the train position.

Operations in subsequent steps S205 to S208 are the same as the operations in steps S205 to S208 in the flowchart according to the first embodiment illustrated in FIG. 6. If the fifth acceleration and the sixth acceleration do not match (step S221: No), the on-board control device 2a determines that the biaxial acceleration sensor 1a is anomalous (step S223). If the first acceleration and the second acceleration do not match (step S208: No), the on-board control device 2a determines that the biaxial acceleration sensor 1a is anomalous (step S223). If the first acceleration and the second acceleration match (step S208: Yes), the on-board control device 2a determines that the biaxial acceleration sensor 1a is normal (step S224). Note that, when the train 10a is not coasting (step S206: No) and the train 10a is not stopped (step S207: No), the on-board control device 2a does not diagnose soundness of the biaxial acceleration sensor 1a at the current operation and assumes that the biaxial acceleration sensor 1a is normal (step S225).

As described above, according to the present embodiment, the on-board control device 2a installed in the train 10a can determine whether or not the detection unit 40 of the second detection axis and the common unit 50 of the biaxial acceleration sensor 1a are normal without using a vibration source that vibrates the biaxial acceleration sensor 1a and regardless of the traveling state of the train 10a.

The configurations illustrated in the above embodiments indicate examples and can be combined with other known techniques. Furthermore, the embodiments can be combined with each other, and some configurations can be partially omitted or changed without departing from the scope.

### REFERENCE SIGNS LIST

1 acceleration sensor; 1a biaxial acceleration sensor; 2, 2a on-board control device; 3 pick-up coil; 4 master controller; 5 tachometer; 6 on-board wireless device; 7 on-board antenna; 8 brake device; 9 propulsion control device; 10, 10a train; 11 ground coil; 12 ground wireless device; 13 ground device; 21 communication unit; 22 storage unit; 23 control unit; 30, 40 detection unit; 31 x-axis acceleration sensor unit; 32, 42 A/D converter; 33, 43 filter unit; 41 z-axis acceleration sensor unit; 50 common unit; 51 power supply unit; 52 control logic unit; 53 FIFO; 54 serial I/O unit; 55 transmission cable; 100, 100a train control system.

1. An on-board control device to be installed in a train, comprising:
a communication interface to be communicable with a tachometer that outputs pulses corresponding to the number of revolutions of wheels of the train, a pick-up coil that receives a telegraph that includes identification information of a ground coil from the ground coil, an acceleration sensor a detection axis of which is provided along a traveling direction of the train, and a master controller;
a memory to store information regarding a gradient value at each position on a train line where the train travels; and
processing circuitry to specify a train position of the train by using information acquired from the pick-up coil and the tachometer, determine a traveling state of the train from information acquired from the master controller, and, when the train coasts or is stopped where an acceleration other than an acceleration caused by a gravity acceleration is not generated, diagnose soundness of the acceleration sensor based on a comparison result obtained by comparing a first acceleration in the traveling direction of the train output from the acceleration sensor with a second acceleration in a traveling direction of the train calculated by using a gravity acceleration and a gradient value at the train position.

2. The on-board control device according to claim 1, wherein
when the acceleration sensor is normal, the processing circuitry calculates a difference between a third acceleration of the train calculated from the pulses output from the tachometer and the first acceleration, determines whether slipping occurs based on a comparison result obtained by comparing the difference with a threshold used to detect the slipping, and determines whether sliding occurs based on a comparison result obtained by comparing the difference with a threshold used to detect the sliding.

3. The on-board control device according to claim 1, wherein
when the acceleration sensor is anomalous, the processing circuitry calculates a fourth acceleration of the train from an increment of the pulses per unit time of the tachometer, determines whether slipping occurs based on a comparison result obtained by comparing the fourth acceleration with a threshold used to detect the slipping, and determines whether sliding occurs based on a comparison result obtained by comparing the fourth acceleration with a threshold used to detect the sliding.

4. The on-board control device according to claim 1, wherein
the acceleration sensor includes a first detection axis that is the detection axis and a second detection axis that is perpendicular to the first detection axis and is provided along a vertical direction with respect to a floor surface of the train, and
the processing circuitry diagnoses soundness of a common device of the first detection axis and the second detection axis included in the acceleration sensor, regardless of a traveling state of the train, based on a comparison result obtained by comparing a fifth acceleration regarding the second detection axis output from the acceleration sensor with a sixth acceleration in the vertical direction with respect to the floor surface of the train, the sixth acceleration being calculated using the gravity acceleration and the gradient value at the train position.

5. An acceleration sensor diagnosis method of an on-board control device to be installed in a train,
the on-board control device including
a communication interface to be communicable with a tachometer that outputs pulses corresponding to the number of revolutions of a wheel of the train, a pick-up coil that receives a telegraph that includes identification information of a ground coil from the ground coil, an acceleration sensor a detection axis of which is provided along a traveling direction of the train, and a master controller,
a memory to store information regarding a gradient value at each position on a train line where the train travels, and
processing circuitry,
the method comprising:
specifying a train position of the train by using information acquired from the pick-up coil and the tachometer by the processing circuitry;
determining a traveling state of the train from information acquired from the master controller by the processing circuitry; and
diagnosing, when the train coasts or is stopped where an acceleration other than an acceleration caused by a gravity acceleration is not generated, soundness of the acceleration sensor, based on a comparison result obtained by comparing a first acceleration in the traveling direction of the train output from the acceleration sensor with a second acceleration in a traveling direction of the train calculated using a gravity acceleration and a gradient value at the train position, by the processing circuitry.

6. The acceleration sensor diagnosis method according to claim 5, wherein
in the diagnosing, when the acceleration sensor is normal, the processing circuitry calculates a difference between a third acceleration of the train calculated from the pulses output from the tachometer and the first acceleration, determines whether slipping occurs based on a comparison result obtained by comparing the difference with a threshold used to detect the slipping, and determines whether sliding occurs based on a comparison result obtained by comparing the difference with a threshold used to detect the sliding.

7. The acceleration sensor diagnosis method according to claim 5, wherein
in the diagnosing, when the acceleration sensor is anomalous, the processing circuitry calculates a fourth acceleration of the train from an increment of the pulses per unit time of the tachometer, determines whether slipping occurs based on a comparison result obtained by comparing the fourth acceleration with a threshold used to detect the slipping, and determines whether sliding occurs based on a comparison result obtained by comparing the fourth acceleration with a threshold used to detect the sliding.

8. The acceleration sensor diagnosis method according to claim 5, wherein
the acceleration sensor includes a first detection axis that is the detection axis and a second detection axis that is perpendicular to the first detection axis and is provided along a vertical direction with respect to a floor surface of the train, and
in the diagnosing, the processing circuitry diagnoses soundness of a common device that is common for the first detection axis and the second detection axis included in the acceleration sensor, regardless of a traveling state of the train, based on a comparison result obtained by comparing a fifth acceleration regarding the second detection axis output from the acceleration sensor with a sixth acceleration in the vertical direction with respect to the floor surface of the train, the sixth acceleration being calculated using the gravity acceleration and the gradient value at the train position.

9. The on-board control device according to claim 2, wherein
the acceleration sensor includes a first detection axis that is the detection axis and a second detection axis that is perpendicular to the first detection axis and is provided along a vertical direction with respect to a floor surface of the train, and
the processing circuitry diagnoses soundness of a common device of the first detection axis and the second detection axis included in the acceleration sensor, regardless of a traveling state of the train, based on a comparison result obtained by comparing a fifth acceleration regarding the second detection axis output from the acceleration sensor with a sixth acceleration in the vertical direction with respect to the floor surface of the train, the sixth acceleration being calculated using the gravity acceleration and the gradient value at the train position.

10. The on-board control device according to claim 3, wherein
the acceleration sensor includes a first detection axis that is the detection axis and a second detection axis that is perpendicular to the first detection axis and is provided along a vertical direction with respect to a floor surface of the train, and
the processing circuitry diagnoses soundness of a common device of the first detection axis and the second detection axis included in the acceleration sensor, regardless of a traveling state of the train, based on a comparison result obtained by comparing a fifth acceleration regarding the second detection axis output from the acceleration sensor with a sixth acceleration in the vertical direction with respect to the floor surface of the train, the sixth acceleration being calculated using the gravity acceleration and the gradient value at the train position.

11. The acceleration sensor diagnosis method according to claim 6, wherein
the acceleration sensor includes a first detection axis that is the detection axis and a second detection axis that is perpendicular to the first detection axis and is provided along a vertical direction with respect to a floor surface of the train, and
in the diagnosing, the processing circuitry diagnoses soundness of a common device that is common for the first detection axis and the second detection axis included in the acceleration sensor, regardless of a traveling state of the train, based on a comparison result obtained by comparing a fifth acceleration regarding the second detection axis output from the acceleration sensor with a sixth acceleration in the vertical direction with respect to the floor surface of the train, the sixth acceleration being calculated using the gravity acceleration and the gradient value at the train position.

12. The acceleration sensor diagnosis method according to claim 7, wherein
the acceleration sensor includes a first detection axis that is the detection axis and a second detection axis that is perpendicular to the first detection axis and is provided along a vertical direction with respect to a floor surface of the train, and
in the diagnosing, the processing circuitry diagnoses soundness of a common device that is common for the first detection axis and the second detection axis included in the acceleration sensor, regardless of a traveling state of the train, based on a comparison result obtained by comparing a fifth acceleration regarding the second detection axis output from the acceleration sensor with a sixth acceleration in the vertical direction with respect to the floor surface of the train, the sixth acceleration being calculated using the gravity acceleration and the gradient value at the train position.
